(19) United States
(12) Patent Application Publication
(10) Pub. No.: US 2006/0123619 A1
(43) Pub. Date: Jun. 15, 2006

(54) Strike and method of forming same

(75) Inventor: Ivar P. Nilsson, Mississauga (CA)

Correspondence Address: KOLISCH HARTWELL, P.C., 200 PACIFIC BUILDING, 520 SW YAMHILL STREET, PORTLAND, OR, 97204, US

(73) Assignee: Lovas Nilsson Holdings Limited

(21) Appl. No.: 11/011,257

(22) Filed: Dec. 13, 2004

(51) Int. Cl. B23P 17/00; B23P 13/04

(52) U.S. Cl. 29/558; 29/417; 292/340

(57) ABSTRACT

A method of forming a strike for a closure involves cutting a metal plate to form a blank having a striker section with a width greater than the thickness of the plate. The striker section may then be compressed to a substantially cylindrical shape. By appropriate choice of the width of the striker section of the blank, after compression, the cylindrical striker section will have a diameter greater than the thickness of the plate.

### BACKGROUND

This invention relates to a strike and a method of forming a strike.

Strikes are used to latch (or lock) doors and other parts that hinge closed. Thus, a vehicle will have a strike for each of its doors and for its trunk. It has been known for unauthorised entry of a vehicle to be gained by breaking the striker section of a strike. For this reason, strikes are made with reinforced striker sections. Indeed, for higher security applications, such as for vehicle doors, striker sections typically have a thickness which is twice that of the remainder of the strike.

One known vehicle strike has a base plate which may be mounted to the vehicle and a separate cylindrical bar bent into a U-shape and attached to the base plate. In manufacturing such a strike, a collar is swaged onto each end portion of the U-shaped bar and the ends of the bar are inserted through openings in the base plate. Next each end of the bar extending through the openings is compressed into a mushroom shape so that the bar is immobily fixed to the base plate. With this arrangement, the cylindrical bar may be chosen to have any desired diameter, such as twice the thickness of the base plate.

Another known vehicle strike is made by bending two blank halves into L-shapes and then welding the two halves together back-to-back to leave a base for attachment to a vehicle and a double thickness striker section.

It would be desirable to provide a strike which may be adapted for higher security applications that is of simpler manufacture.

### SUMMARY OF INVENTION

This invention provides a method of forming a strike for a closure. The method involves cutting a metal plate to form a blank having a striker section with a width greater than the thickness of the plate. The striker section may then be compressed to a substantially cylindrical shape. By appropriate choice of the width of the striker section of the blank, after compression, the cylindrical striker section will have a diameter greater than the thickness of the plate.

Accordingly, this invention provides a method of forming a strike for a closure, comprising: cutting a metal plate to form a blank having a striker section with a width greater than the thickness of the plate; and compressing the striker section to a substantially cylindrical shape.

In accordance with another aspect of this invention, there is provided a strike comprising: a body formed from a single piece of metal; a plate-like base having mounting holes for mounting the strike; and a cylindrical striker section having a diameter greater than a thickness of the plate-like base.

Other features and advantages of the application will be apparent from the following description in conjunction with the figures.

### BRIEF DESCRIPTION OF THE DRAWINGS

In the figures which illustrate example embodiments of the invention,

FIG. 1 is a schematic diagram of a progressive die and its input and output,

FIG. 2a is a plan view of a strike blank attached to drive strips of a progressive die,

FIG. 2b is a side view of the strike blank of FIG. 2a,

FIG. 3 is a plan view of a bent strike blank attached to drive strips of a progressive die,

FIG. 4 is a side view of a bent and deformed strike blank,

FIG. 5a is a side view of a partially formed strike made in accordance with one embodiment of this invention,

FIG. 5b is a side view of a partially formed strike made in accordance with another embodiment of this invention,

FIG. 6 is a side view of a more completely formed strike,

FIG. 7 is a side view of a completed strike,

FIG. 8 is a perspective view of the strike of FIG. 7,

FIGS. 9 to 11 are side, top, and front views, respectively, of the strike of FIG. 7,

FIG. 12a is a schematic view of a die,

FIG. 12b is a magnified view of the area marked 12b in FIG. 12a,

FIG. 13 is a schematic view of a portion of a die made in accordance with another embodiment of the invention, and

FIG. 14 is a plan view of a strike blank made in accordance with another embodiment of this invention.

### DETAILED DESCRIPTION

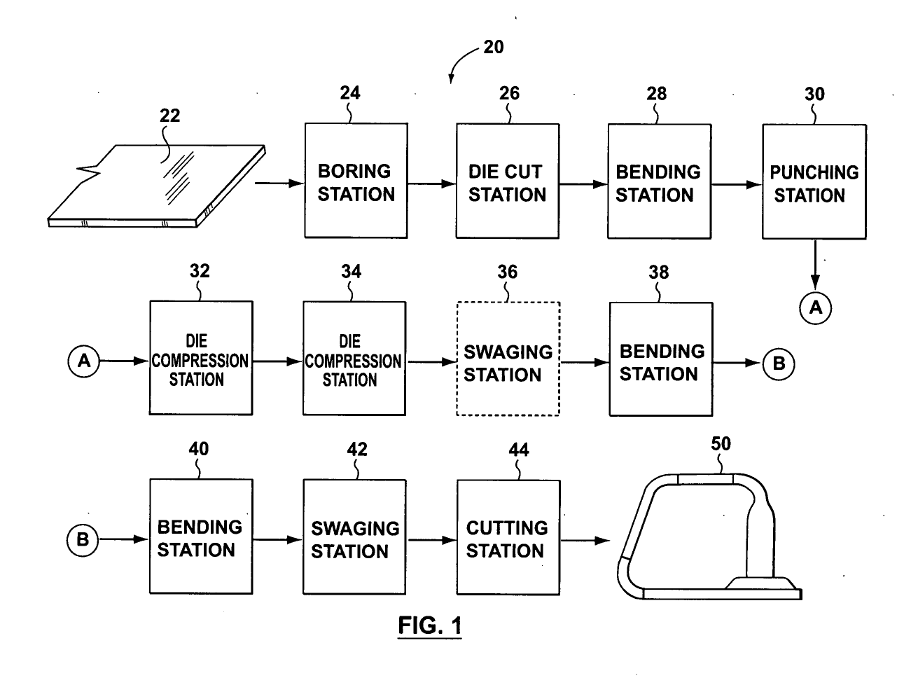

A strike in accordance with this invention may be manufactured on a progressive die, such as the progressive die illustrated schematically at 20 in FIG. 1. Turning to FIG. 1, a metal band 22 (i.e., a plate of indeterminate length) is fed to the progressive die. The die has, in downstream order, a boring station 24, a first die cutting station 26, a first bending station 28, a punching station 30, a rough die compression station 32 and a fine die compression station 34, an optional swaging station 36, two further bending stations 38, 40, a swaging station 42 and a final cutting station 44 from which are output strikes 50.

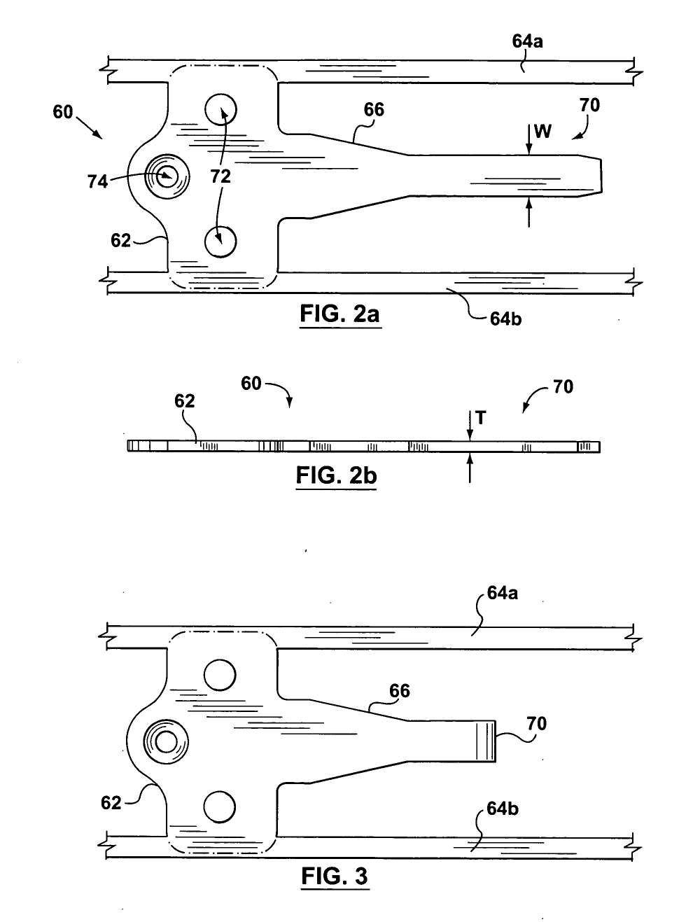

In a conventional fashion, the progressive die indexes the band forward. At boring station 24, a pair of mounting holes 72 (seen in FIG. 2a) may be drilled into the band and a tapered striker section supporting hole 74 (also seen in FIG. 2a) reamed into the band.

The bored section of the band is then indexed forward to die cut station 26 which cuts material from the band 22 in order to form a strike blank which is attached by a pair of strips that are all that remain of the band. Turning to FIGS. 2a and 2b, the strike blank 60 has a base section 62 which is attached to the strips 64a, 64b and a medial arm 66 with a striker section 70. The entire blank, having been cut from a plate-like band, has a thickness T. The striker section 70 has a width, W.

Utilising the remaining strips 64a, 64b of the band as drive strips, the progressive die indexes the blank forward to bending station 28 whereat the striker section 70 of the blank is bent downwardly to make about a right angle with the balance of the blank. This bent blank is illustrated in FIG. 3.

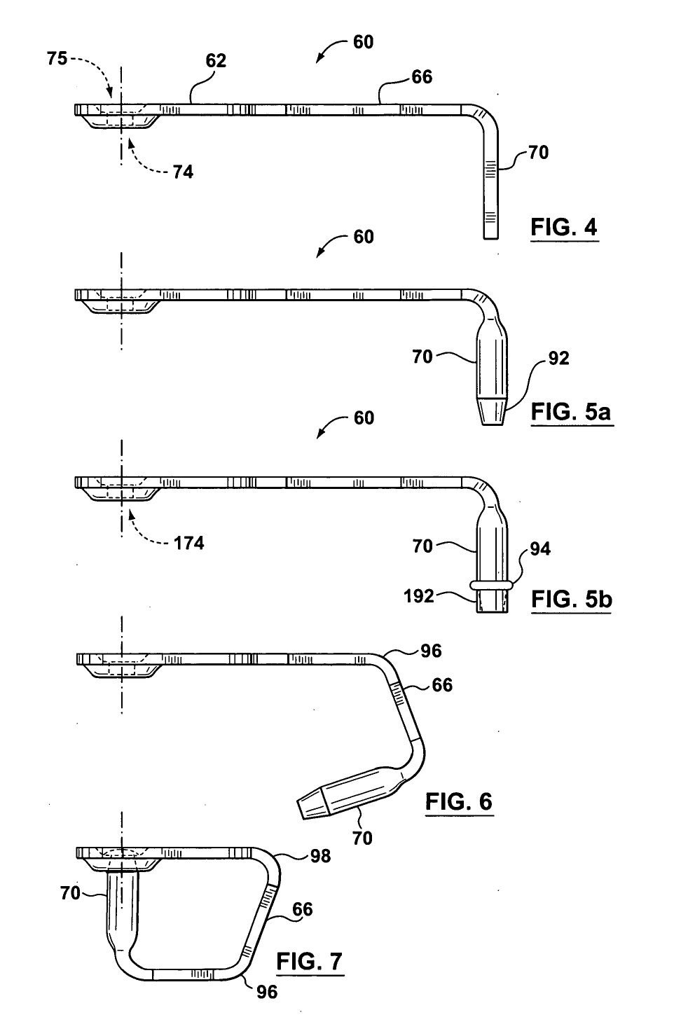

The bent blank then progresses to the punching station 30 whereat the base of the blank is punched to form a depression 75 centered about the reamed hole 74, as illustrated in FIG. 4.

The bent blank is then indexed forward to the rough die compression station 32 whereat die halves are brought together to compress the striker section 70 of the blank into a rough cylindrical shape. The die is illustrated schematically in FIGS. 11a and 11b. Referring to FIGS. 11a and 11b, it will be apparent that the die 80 is oriented so that the dies halves 82, 84 converge on opposite sides of the striker section 70 along its width dimension, W (FIG. 2a). Each die half has a half cylindrical die face 86. The die has a base 88. Wedge-shaped cams 90 may be forced into the die to force the die halves together. This compresses the striker section 70 from its rectangular outline (illustrated in solid line in FIGS. 11a and 11b) to a rough cylindrical shape (indicated in ghost in FIGS. 11a and 11b).

The partially finished strike may then progress to the next die compression station 34 where the striker section is again compressed to a more refined cylindrical shape. At these die compression stations an end portion 92 of the blank (beyond the striker section) is tapered. The partially finished strike at this stage is illustrated in FIG. 5a.

As an alternative, the striker section supporting hole may be drilled rather than reamed, as shown at 174 in FIG. 5b. In this instance, the end 192 of the blank is not provided with a taper and instead the partially finished strike progresses to a swaging station 36 whereat a collar 94 is swaged onto the end 192, also as illustrated in FIG. 5b.

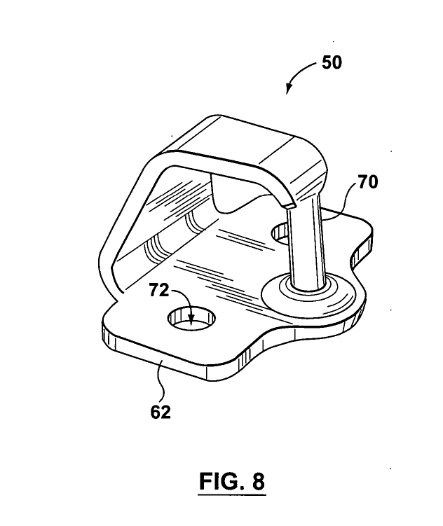

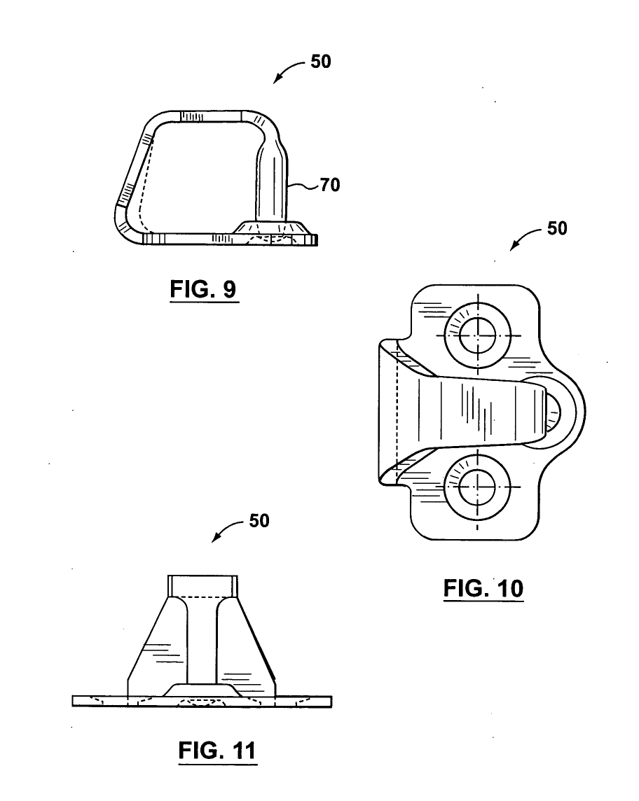

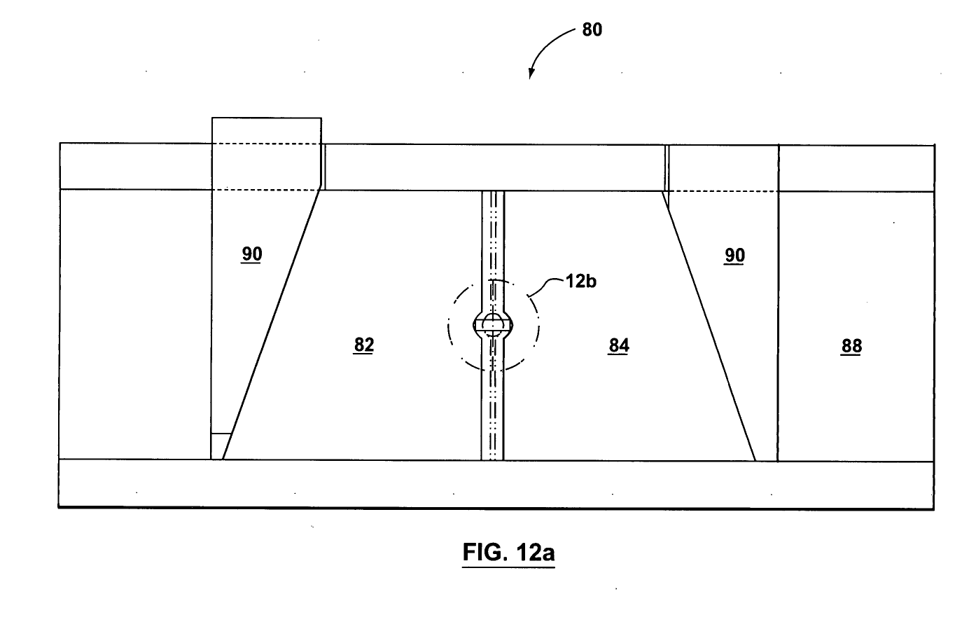

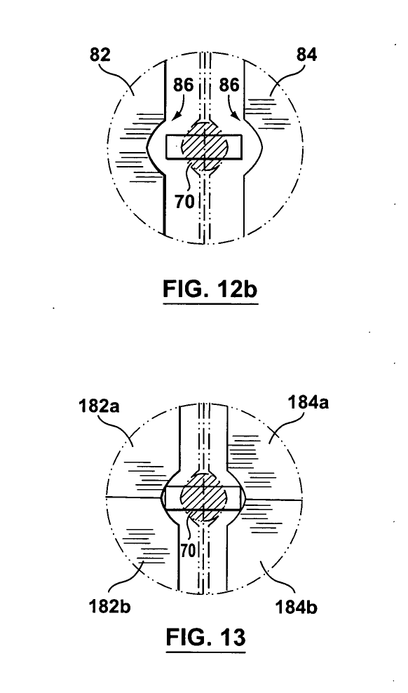

The partially finished strike then progresses to bending station 38 whereat arm 66 is bent at elbow 96 (FIG. 6) and to bending station 40 whereat arm 66 is bent at shoulder 98 (FIG. 7) so that the end 92 (or 192) of the partially finished strike penetrates the striker section supporting hole 74 (or 174). The substantially completed strike then progress to a swaging station whereat the end 92 (or 192) of the striker section is mushroomed so that the end is locked into the hole 74 (or hole 174). The completed strike then progresses to the cutting station 44 whereat it is cut away from the drive strips 64a, 64b (FIG. 3). FIGS. 8 to 11 illustrate the completed strike 50.

As noted hereinbefore, to obtain a striker section of sufficient strength, in known strikes, two blank halves may be welded together to obtain a double thickness striker section or a separate, thicker, part may be incorporated in the strike. With this invention, a double thickness striker section may be obtained from a unitary blank as follows.

Since the blank was cut from a plate, the cross-sectional shape of the striker section 70 of the blank is rectangular. Therefore, the cross-sectional area of the striker section is the product of the width (W) and thickness (T) of the striker section. After the die press operations, the striker section is cylindrical, thus, its cross-sectional shape is circular and the cross-sectional area of the striker section is π·r², where r is the radius of the circular shape. Since the compression of the striker section is radially directed, the cross-sectional area of the striker section after compression should be equal to its cross-sectional area before compression. Thus:
W·T=π·r²

So if the plate from which the blank is cut, and hence the striker section of the blank, has a thickness, T, we want the diameter of the striker section after compression to be 2T. This requires that:
r=2T/2 =T
Thus:
W·T=π·T²,
So W=π·T.

Therefore, the width to thickness ratio of the striker section of the blank should be π·T:T=π:1, if the diameter of the striker section after die compression is to be double the thickness of the blank.

Indeed, even with the width to thickness ratio of the striker section of the blank as low as 2:1, the diameter of the striker section after compression will be more than 1.5 times the thickness of the blank, which may be sufficient for many circumstances. The width to thickness ratio of the striker section of the blank will normally be chosen such that the diameter of the striker section after compression will be no more than about 2.2 times the thickness of the blank, with 2.5 times the thickness of the blank often representing about the maximum limit. This reason for the upper limit is that with higher width to thickness ratios of the striker section of the blank, the striker section will tend to fold during compression and these folds remain in the material, thereby substantially reducing the strength of the striker section.

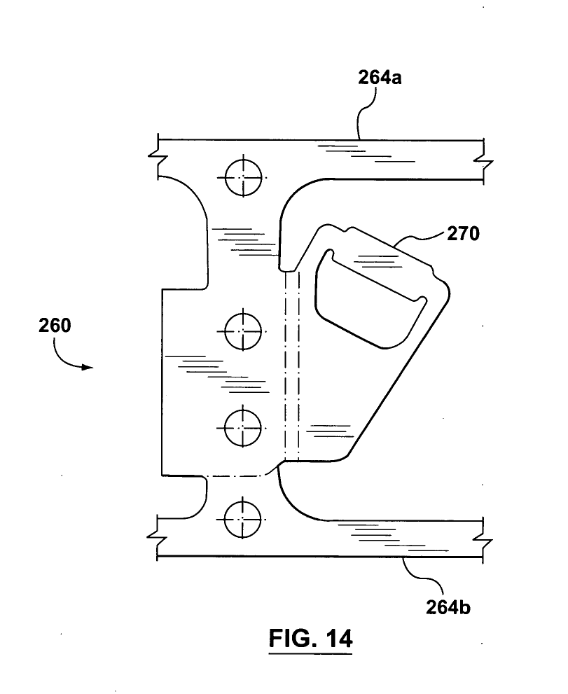

Optionally, bending station 28 may be placed after the die compression stations rather than before these stations. In this instance, the die compression stations must be reconfigured so as to be able to compress the striker section 70 when it is between the drive strips 64a, 64b. The constraint in this regard is the small operating space for the dies between the striker section 70 and the strips 64a, 64b. This requires that the die sections be much thinner. However, the pressure required to compress the striker section into a cylindrical shape is considerable such that if two thin die halves are used, these die halves are likely to break. It is recognised that the likely fracture point for each of two die halves is at their thinnest point, namely, the apex of their half cylindrical die faces 84. Therefore, to solve this problem, rather than using two die halves, four die sections may be used, as illustrated by die sections 182a, 182b, 184a, 184b in FIG. 13.

In some instances, it may be beneficial to use one die half for one side of the die and two die sections for the other.

While the progressive die 20 has been described with two die compression stations 32, 34, for some applications, it may be that the striker section is sufficiently formed with a single die compression station. Also, boring station 26 could be replaced by a die cutting station to cut (punch) holes 72, 174. In such instance, this station could be combined with station 26. Optionally, swaging station 42 could be omitted as even without mushrooming the end of the strike, this end will be firmly planted in hole 74 (or 174). In instances where it is not problematic for the end 92 (or 192) of the strike to project below its base 62, punching station 30 may be omitted such that no depression 75 to accommodate end 92 (or 192) is formed in the base 62.

The shape of the blank is dependent upon the use for the strike. Turning to FIG. 14, a blank 260 having a different shape is illustrated extending between two drive strips 264a, 264b. The blank has a striker section 270. Various folds may be made in blank 260 to progress it toward forming a strike. Additionally, as with blank 60 (FIG. 2a), the striker section 270 will be compressed into a cylindrical shape having a greater diameter than the thickness of the blank.

While the blanks have been described as being formed into strikes using a progressive die, equally a transfer die could be used.

Further, conventional, modifications will be apparent. For example, rather than reaming the tapered striker section supporting hole 74, this hold may be formed by punching and coining.

It will be apparent that the foregoing described methods form a one piece strike with a thickened (and therefore strong) striker section.

Other modifications will be apparent to those skilled in the art and, therefore, the invention is defined by the claims.

What is claimed is:

1. A method of forming a strike for a closure, comprising:
cutting a metal plate to form a blank having a striker section with a width greater than the thickness of said plate;
compressing said striker section to a substantially cylindrical shape.

2. The method of claim 1 wherein said width of said striker section prior to said compressing is at least about twice the thickness of said blank.

3. The method of claim 1 wherein said width of said striker section prior to said compressing is about π times the thickness of said blank.

4. The method of claim 1 wherein the ratio of the width of said striker section prior to said compressing to the thickness of said blank is such that, after said compressing, said striker section has a diameter of 1.5 to 2.5 time the thickness of said blank.

5. The method of claim 2 wherein said striker section is toward one end of said blank and wherein said cutting forms said blank with a hole spaced from said striker section and said one end.

6. The method of claim 5 further comprising:
folding said striker section over so that said one end is received by said hole.

7. The method of claim 6 further comprising:
mushrooming said one end so as to preclude removal of said mushroomed end from said hole.

8. The method of claim 7 further comprising, prior to said folding, swaging a collar on said striker section such that, after mushrooming said end, said collar is at an opposite side of said plate to that of said mushroomed end.

9. The method of claim 7 wherein said cutting comprises one of drilling or punching out said hole.

10. The method of claim 7 wherein said metal plate is a metal band and said cutting leaves at least one drive strip attached to said blank and further comprising transporting said blank past a compressing station to effect said compressing and a folding station to effect said folding utilising said at least one drive strip.

11. The method of claim 6 wherein said folding is subsequent folding and further comprising initially folding said striker section out of a plane of a remainder of said blank prior to said compressing.

12. The method of claim 2 wherein said compressing comprises at least one die pressing operation.

13. The method of claim 12 wherein said compressing comprises a first die pressing operation to compress said striker section to a rough cylindrical shape and a second die pressing operation to compress said striker section to a more refined cylindrical shape.

14. The method of claim 12 wherein said at least one die pressing operation occurs while said striker section lies in a plane of a remainder of said blank and wherein said die pressing operation comprises utilising at least three die sections which, together, form a cylindrical die cavity.

15. The method of claim 14 wherein said at least three die sections comprise four die sections.

16. A strike comprising:
a body formed from a single piece of metal;
a plate-like base having mounting holes for mounting said strike;
a cylindrical striker section having a diameter greater than a thickness of said plate-like base.

17. The strike of claim 16 wherein said cylindrical striker section has a diameter of 1.5 to 2.5 times the thickness of said plate-like base.

18. The strike of claim 16 wherein said cylindrical striker section has a diameter of about twice the thickness of said plate-like base.
